(19) United States
(12) Patent Application Publication
(10) Pub. No.: US 2007/0176852 A1
(43) Pub. Date: Aug. 2, 2007

(54) Display apparatus for a 3D solid image

(75) Inventor: Teruhisa Yokosawa, Nagano (JP)

Correspondence Address: RABIN & Berdo, PC, 1101 14TH STREET, NW, SUITE 500, WASHINGTON, DC, 20005, US

(73) Assignee: Fuji Electric Device Technology Co., Ltd, Tokyo (JP)

(21) Appl. No.: 11/638,698

(22) Filed: Dec. 14, 2006

(30) Foreign Application Priority Data
Dec. 14, 2005 (JP) JP2005-360976

(51) Int. Cl. G09G 3/00

(52) U.S. Cl. 345/32

(57) ABSTRACT

A two-dimensional image is displayed on a flat display device. A solid diffusion panel which is composed of six transparent panels is disposed in an optical path of image light emitted from the flat display device and is moved periodically in a depth direction. Sectional images of a 3D solid image are drawn on reflection surfaces of the six transparent panels by means of image light emitted from the flat display device. Because of the afterimage effect, a viewer can recognize, as a 3D solid image, reflection light coming from the solid diffusion panel.

### BACKGROUND OF THE INVENTION

1. Field of the Invention

The present invention relates to a display apparatus for a 3D solid image, which displays a 3D solid image in a three-dimensional space.

2. Description of the Related Art

Solid image displays are expected to be used widely in the following fields if requirements relating to the display performance and the cost are satisfied. In the field of medicine, a solid image display is very effective because displaying 3D data of a CT scan or the like makes it possible to check a focus before an operation. A solid image display is also effective in the architecture field because stereoscopic viewing of CAD data enables a check of spatially extending components. In the design of facilities, robots, etc., viewing a realistic spatial arrangement of components enables efficient design. In urban development and regional development, the use of a 3D solid image enables a more realistic study. In air traffic control, a solid image display makes it possible to instantaneously recognize the positions and altitudes of airplanes and to thereby reduce the probability of occurrence of dangerous events such as near misses. In the self-defense field, solid image displays will be utilized widely because this makes it possible to instantaneously recognize 3D topological information and spatially-related information. In the entertainment field, such as a field in which a player enjoys a game by manipulating an image, solid image displays will enable a new type of entertainment in which plural persons view and manipulate a 3D image simultaneously from various angles.

There are two methods for displaying a 3D solid image in a three-dimensional space. In one method, a human is caused to feel as if he or she were watching a solid by utilizing the difference between visual angles of the right and left eyes. In the other method, an image is actually displayed in a three-dimensional space so as to be viewable from all directions (360°). As disclosed in JP-A-2000-338900, for example, an exemplary method of actually displaying an image in a three-dimensional space is such that an actual solid image is displayed in a three-dimensional space by using a laser.

However, as described in JP-A-2000-115812, for example, the method utilizing the difference between visual angles of the right and left eyes exhibits a problem such that an image looks like a solid if it is viewed from a certain direction but it cannot be seen or does not look like a solid if it is viewed from another location. On the other hand, the method using a laser, etc. exhibits other problems, in that a large-scale apparatus is required, limitations on size, weight, etc. restrict places where such a system can be installed, and the cost is high.

### SUMMARY OF THE INVENTION

An object of the present invention is therefore to provide a display apparatus for a 3D solid image, which is free of the above problems.

The invention provides a display apparatus for a 3D solid image, comprising a display device for displaying a two-dimensional image; a transparent or semi-transparent reflection member which can be moved in a depth direction and has, in an optical path of light emitted from a display screen of the display device, a surface for reflecting the light emitted from the display screen of the display device; driving means for driving the reflection member so as to move it periodically in the depth direction; and image data generating means for generating data of the two-dimensional image to be displayed by the display device so that a sectional image as obtained by cutting a 3D solid image by the surface of the reflection member being moved will be drawn on the surface of the reflection member in synchronism with a movement of the reflection member by means of light. emanating from the two dimensional image displayed on the display device.

In the display apparatus for a 3D solid image having the above configuration, as the reflection member is moved, the reflection surface of the reflection member reflects, in its optical path, light emitted from the display screen of the display device that displays a two-dimensional image. The display device displays different images (cross sections of a solid image) one after another in synchronism with the movement of the reflection member. Since afterimages remain in the memory of a viewer and the reflection member is moving fast, the viewer can feel as if a solid image exists in the space. This display apparatus for a 3D solid image can be implemented in a simple configuration, can be reduced in size, is less prone to place restrictions on installation locations, and can be reduced in cost.

In the invention, the reflection member may have plural reflection surfaces. In this case, each reflection surface is only required to display part of a solid image and hence need not move so as to cover the entire display area of the solid image. This increases the degree of freedom of design of the driving means and the reflection member, can ameliorate deterioration of the driving portion effectively, and enables display of a fast-moving solid image.

In a preferred embodiment of the invention, the frequency of the movement of the reflection member may be higher than or equal to 5 Hz. This allows even a moving solid image to be seen because of the afterimage effect.

In one preferred embodiment of the invention, the driving means may drive the reflection member so as to translate it periodically in the optical path of light emitted from the display screen of the display device.

In another preferred embodiment of the invention, the driving means may drive the reflection member so as to rotate it periodically in the optical path of light emitted from the display screen of the display device.

The reflection member may optionally be shaped so as to include part of a curved surface, which is expressed as
X=r*cos Θ
Y=r*sin Θ
Z=a*Θ
where X, Y, and Z are coordinates of the three-dimensional orthogonal coordinate system, r and Θ are a length of a radius vector and a polar angle of the polar coordinate system, and a is a constant.

In this case, since the height Z is proportional to the angle Θ, sectional images to be displayed on the curved surface being rotated can be calculated merely by additions. Therefore, the calculation speed can be increased and the circuits and the algorithm can be simplified.

Glass beads may optionally be stuck to the surface of the reflection member. This enables display of a 3D solid image that is high in luminance.

A fluorescent paint may optionally be stuck to the surface of the reflection member. This enables display of a 3D solid image that is high in luminance.

The display device may be a flat display device such as a liquid crystal display, an EL display, or a CRT display. This enables use of common two-dimensional display devices.

Alternatively, the display device may be a projection display device such as a liquid crystal projector or a DLP projector. In this case, the use of a high-luminance light source enables display of a 3D solid image that is high in luminance.

An optical system for changing at least one of a traveling direction and an image forming position of light emitted from the display screen of the display device may optionally be disposed between the reflection member and the display device. In this case, light emitted from the display screen of the display device can reach the surface of the reflection member without being diffused. This enables display of a 3D solid image that is high in luminance.

The optical system may also be moved in synchronism with the reflection member.

The image data generating means may generate the two-dimensional image data in synchronism with a signal that is supplied from the driving means and relates to the driving of the reflection member. This makes it possible to suppress blurring effectively and to thereby display a stable 3D solid image.

The display apparatus may be such that the display device displays a monochrome two-dimensional image and the reflection member has plural reflection surfaces that are provided with materials that reflect light while converting it into light beams of different colors, respectively, so that a color solid image is synthesized. In this case, since the display device can produce monochrome light that is high in luminance and density, a 3D solid image can be displayed which is high in luminance and density.

Plural display apparatus for a 3D solid image described above may be arranged adjacent to each other so that a 3D solid image is displayed by the plural reflection members in a divisional manner. This makes it possible to display a 3D solid image in a large space.

The invention makes it possible to provide a display apparatus for a 3D solid image which can be implemented in a simple configuration, can be reduced in size, is less prone to restrict installation locations, and can be reduced in cost.

### BRIEF DESCRIPTION OF THE DRAWINGS

FIG. 1 shows the entire display apparatus for a 3D solid image according to a first embodiment.

FIG. 2 shows exemplary storage contents, in a display buffer, of an image to be supplied to a two-dimensional display device.

FIG. 3 shows a solid figure to be displayed.

FIG. 4A shows a solid diffusion panel 1 located at the origin and calculation results of surfaces to cut a solid image when the solid diffusion panel 1 is located there.

FIG. 4B shows an image that is calculated by using the calculation results of FIG. 4A as an image to be displayed on a two-dimensional flat display device 2.

FIG. 5A shows calculation results of surfaces to cut the solid figure when the solid diffusion panel 1 has been moved in the depth direction.

FIG. 5B shows an image that is calculated by using the calculation results of FIG. 5A as an image to be displayed on the two-dimensional flat display device 2.

FIG. 6A shows calculation results of surfaces to cut the solid figure when the solid diffusion panel 1 has been moved further in the depth direction.

FIG. 6B shows an image that is calculated by using the calculation results of FIG. 6A as an image to be displayed on the two-dimensional flat display device 2.

FIG. 7A shows calculation results of surfaces to cut the solid figure when the solid diffusion panel 1 has been moved still further in the depth direction.

FIG. 7B shows an image that is calculated by using the calculation results of FIG. 7A as an image to be displayed on the two-dimensional flat display device 2.

FIG. 8A shows a superimposed image (3D solid image) of sectional images that are displayed in the solid diffusion panel 1 at certain time intervals.

FIG. 8B shows a superimposed image of images that are displayed on the two-dimensional flat display device 2 at the same time intervals.

FIG. 9 shows the entire display apparatus for a 3D solid image according to a second embodiment.

FIG. 10A and 10B show a solid image displayed in a solid diffusion panel 1 and an image displayed on the display screen of a two-dimensional flat display device 2 at a certain time point.

FIG. 11A and 11B show a solid image displayed in the solid diffusion panel 1 and an image displayed on the display screen of the two-dimensional flat display device 2 at another time point.

FIG. 12A and 12B show a solid image displayed in the solid diffusion panel 1 and an image displayed on the display screen of the two-dimensional flat display device 2 at yet still another time point.

FIG. 13A and 13B show a solid image displayed in the solid diffusion panel 1 and an image displayed on the display screen of the two-dimensional flat display device 2 at yet another time point.

FIG. 14 shows the entire display apparatus for a 3D solid image according to a third embodiment.

FIG. 15 shows the entire display apparatus for a 3D solid image according to a fourth embodiment.

### DESCRIPTION OF THE PREFERRED EMBODIMENTS

Preferred embodiments of the present invention will be described hereinafter.

### Embodiment 1

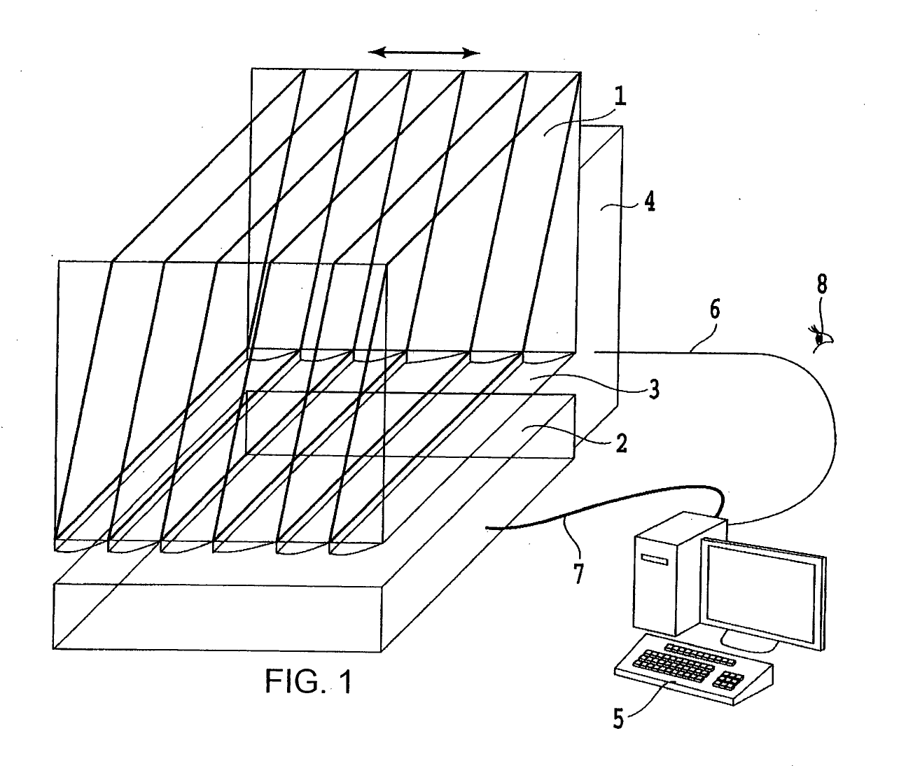

FIG. 1 shows the entire display apparatus for a 3D solid image according to a first embodiment. Reference numeral 2 denotes a flat display device as a display device for displaying a two-dimensional image. The flat display device 2 displays a two-dimensional image on the display screen on the basis of two-dimensional image data that are supplied from a computer system 5 via an output cable 7. Reference numeral 1 denotes a solid diffusion panel as a reflection member having six films that are arranged at regular intervals. The solid diffusion panel 1 is supported by a driving device 4 (its operation will be described later) so as to be located right over the display screen of the flat display device 2 (i.e., in the optical path of image light over the display screen).

Each film of the solid diffusion panel 1 is a film produce by spraying glass beads on a transparent (or semi-transparent), planar mesh film. The film having the above structure can reflect (diffuse) light with higher reflection efficiency by means of the glass beads than a white plate, as well as can transit light. Each film is inclined toward a person 8 who is located on a line perpendicular to its surface and a lens 3 is disposed at its bottom. Each lens 3 is disposed close to the display screen of the flat display device 2 and changes the paths of image light emitted from the display screen so that the image light shines on the inclined film surface. The driving device 4 drives the solid diffusion panel 1, that is, reciprocates those in the horizontal direction (in the depth direction for the person 8 who is looking at the solid diffusion panel 1). The driving device 4 outputs a positive pulse to the computer system 5 via a position information signal line 6 when the solid diffusion panel 1 is located at the origin of the reciprocation movement.

When an image is displayed on the display screen of the flat display device 2, the light emanating from the displayed image is reflected by the film surfaces of the solid diffusion panel 1 and hence the person 8 who is watching the solid diffusion panel 1 can see an image there. In the following, these reflection portions will be called image display portions of the solid diffusion panel 1. When a solid image is displayed by the image display portions, each film surface displays a cross section of the solid image.

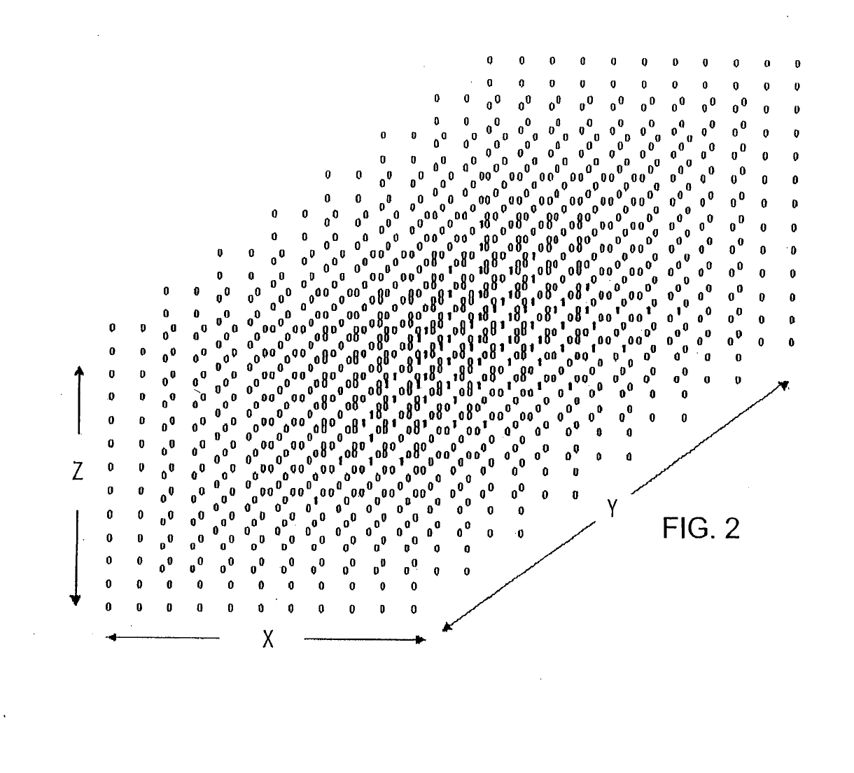

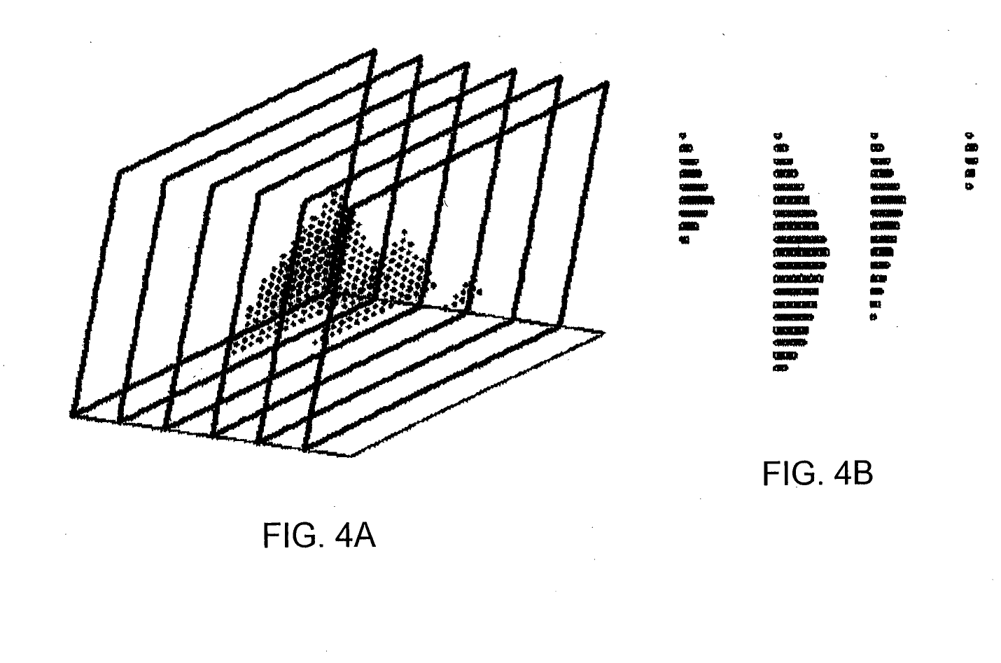

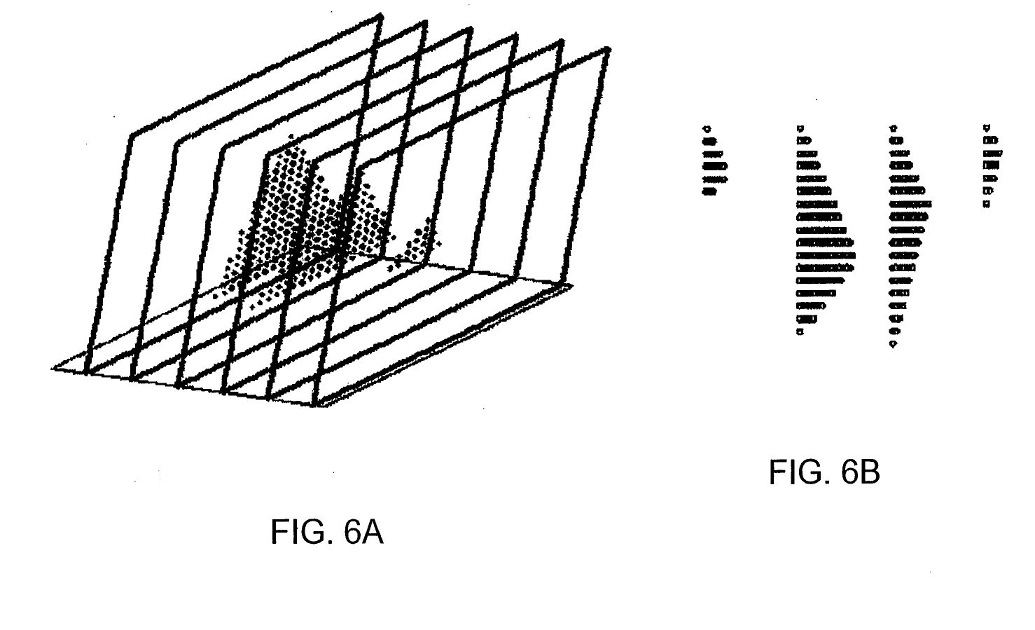

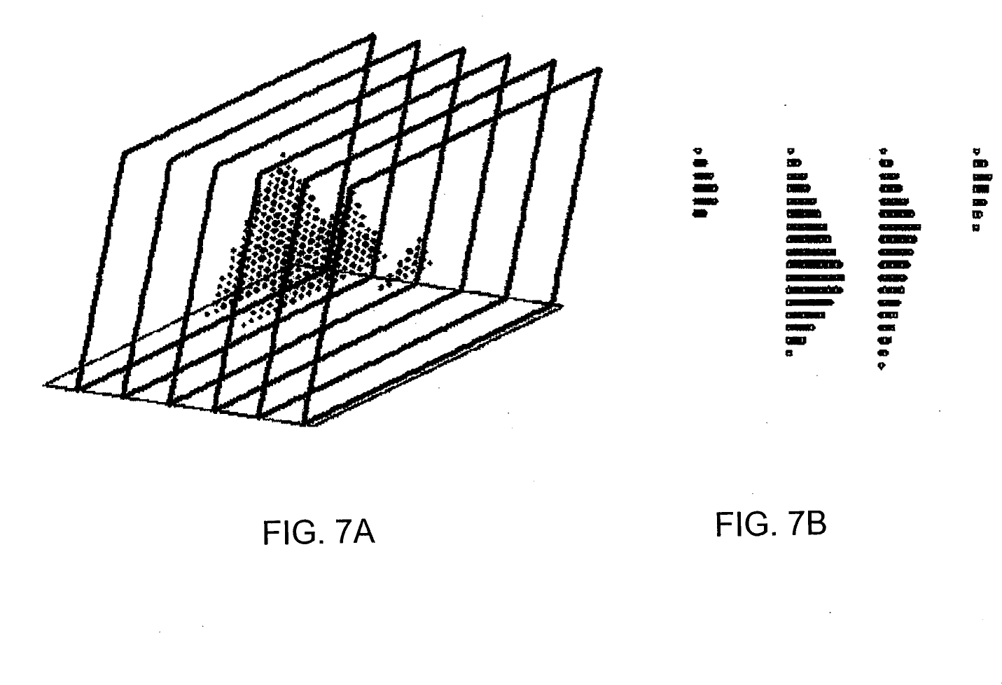

A solid image can be displayed by the image display portions of the solid diffusion panel 1 in the following procedure. Data of a 3D solid image generated by the computer system 5 are developed in an XYZ buffer shown in FIG. 2 (X: screen width direction; Y: screen depth direction; Z: height direction). Information of sectional images corresponding to the film surfaces of the solid diffusion panel 1 located in a three-dimensional space is extracted from the buffer and displayed. An actual display method will be described below with reference to FIG. 4A-4B to FIG. 8A-8B.

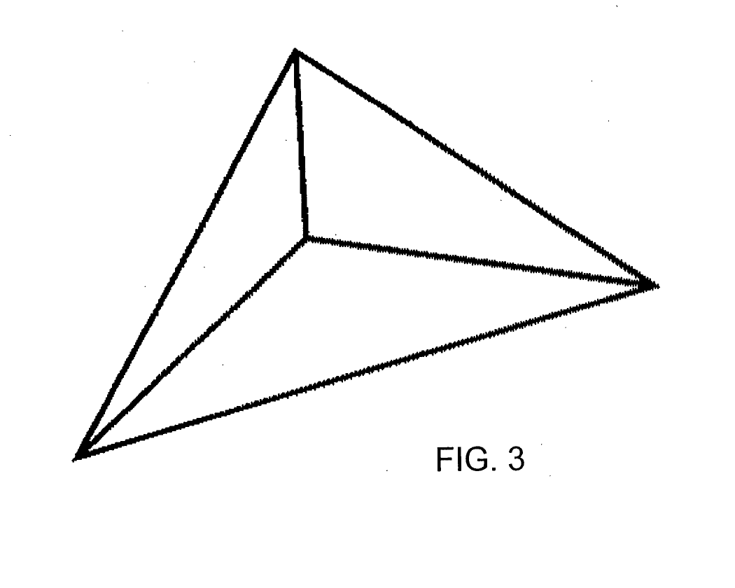

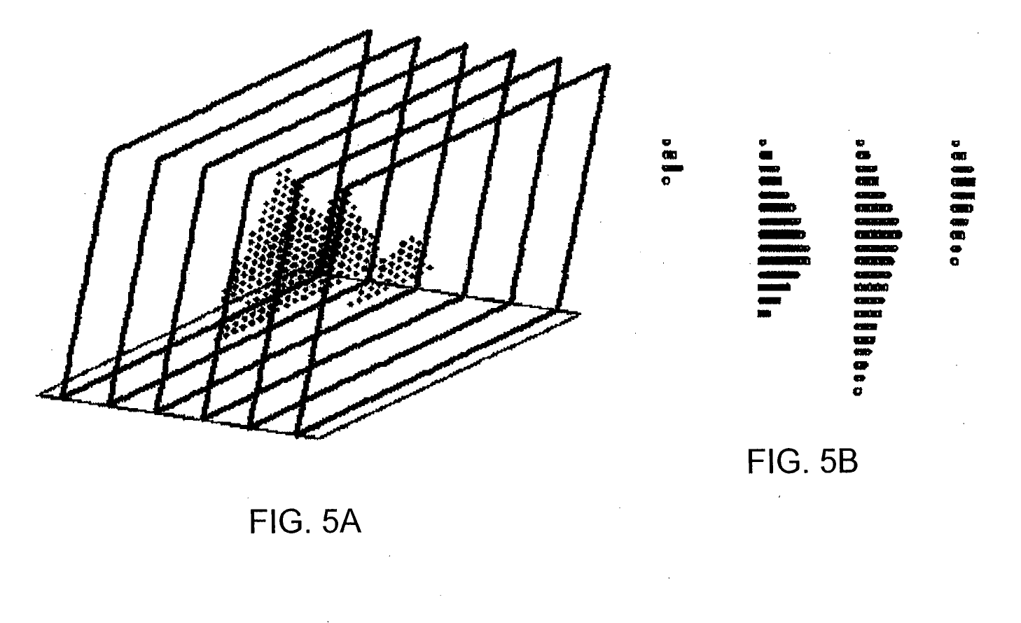

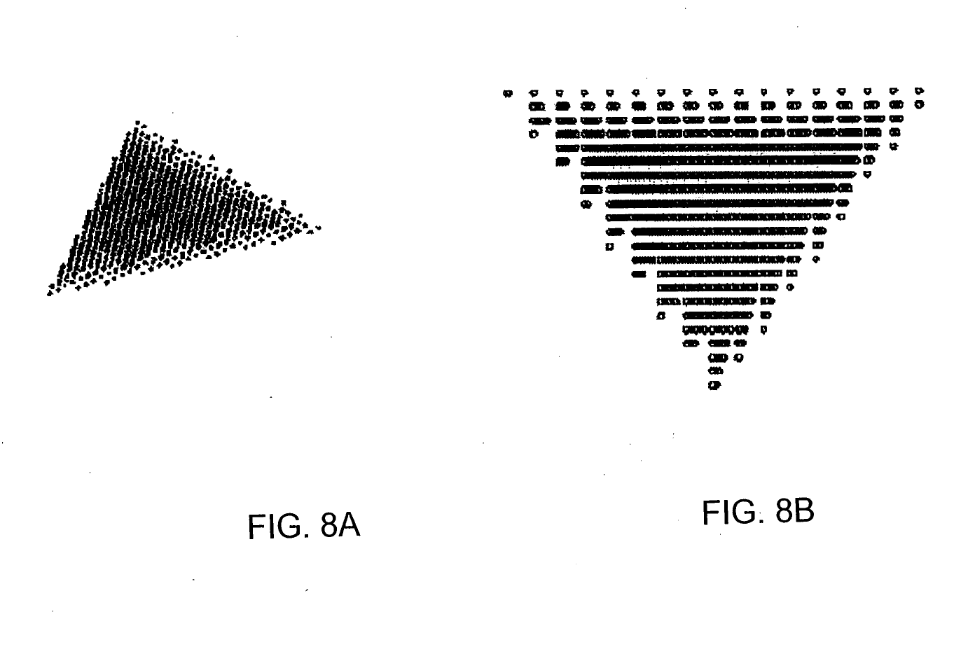

FIG. 3 shows a solid figure to be displayed. FIG. 4A shows the solid diffusion panel 1 located at the origin and calculation results of surfaces to cut a solid figure when the solid diffusion panel 1 is located there. FIG. 4B shows an image that is calculated by using the calculation results of FIG. 4A as an image to be displayed on the two-dimensional flat display device 2. Likewise, FIG. 5A-5B, 6A-6B, and 7A-7B show calculation results of surfaces to cut the solid figure and images that are calculated by using the calculation results of FIG. 5A, 6A, and 7A, respectively, as images to be displayed on the two-dimensional flat display device 2 as the solid diffusion panel 1 is moved in the depth direction. The shape of the solid diffusion panel 1 is almost fixed. Therefore, once its sectional shapes are formed, cutting of an image that is developed in the XYZ buffer can easily be performed merely by additions using a pointer. A 3D solid image can be displayed in the space by outputting images to the flat display device 2 in synchronism with the movement of the solid diffusion panel 1. FIG. 8A shows a superimposed image (3D solid image) of sectional images that are displayed in the solid diffusion panel 1 at certain time intervals, and FIG. 8B shows a superimposed image of images that are displayed on the two-dimensional flat display device 2 at the same time intervals. Since the above sectional images are displayed in a sufficiently short period, they remain as afterimages and hence a human feels as if a 3D solid image were being displayed in the space.

More specifically, the solid diffusion panel 1 is preferably vibrated in a sine wave of 7.5 Hz. In response to a positive pulse that is supplied when the solid diffusion panel 1 reaches the origin, the computer system 5 outputs, to the flat display device 2, two-dimensional image signals that are 60-Hz non-interlaced signals (standard RGB signals). Two-dimensional image signals of five frames are prepared, and current signals are updated every 16.6 ms. Since the solid diffusion panel 1 is reciprocated, images of five frames are generated so as to correspond to respective positions of the reciprocation of the solid diffusion panel 1. The images are denoted by A, B, C, D, and E in which the image C corresponds to the origin. The image C is displayed first and the solid diffusion panel 1 starts to move from the origin. In this case, the images are output repeatedly in order of C→D→E→D→C→B→A →B→C.

In this embodiment, all of the above processing is performed by software of the computer system 5. However, it is more efficient to perform the above processing by such hardware as a dedicated display adaptor, in which case the load of the computer system 5 is light.

A 3D solid image being displayed can be moved by rewriting the contents of the XYZ buffer while it is being displayed. Furthermore, a larger 3D solid image can be displayed in a larger space by arranging, adjacent to each other, plural 3D solid image display apparatus each having the above-described configuration and displaying the 3D solid image in the solid diffusion panels 1 in a divisional manner.

### Embodiment 2

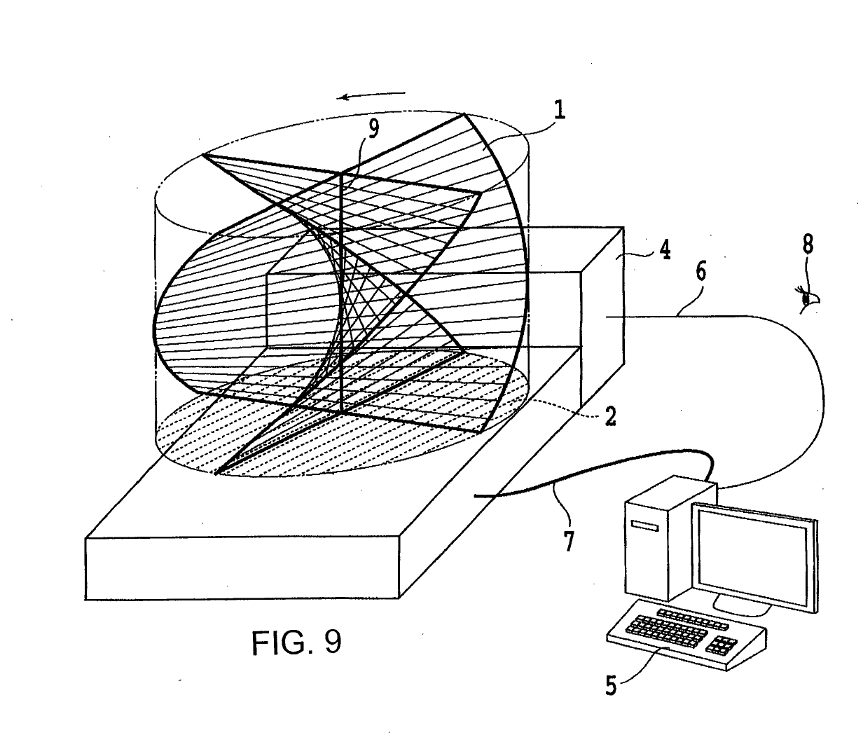

FIG. 9 shows the entire display apparatus for a 3D solid image according to a second embodiment. As shown in FIG. 9, this embodiment is different from the first embodiment in the structure of the solid diffusion panel 1, its driving method, and the image data supplied to the flat display device 2.

A driving device 4 is disposed above the flat display device 2 perpendicularly to its display screen, and the driving device 4 is connected to the rotary shaft 9 via a proper arm (not shown). Four panels (curved plates) 1a, 1b, 1c, and 1d constituting the solid diffusion panel 1 are fixed to the rotary shaft 9. The driving device 4 rotates the curved plates 1a, 1b, 1c, and 1d on the rotary shaft 9. The four curved plates 1a, 1b, 1c, and 1d are fixed to the rotary shaft 9 so as to be arranged at angular intervals of 90°. The bottom end and the top end of each panel are straight, and each panel is curved in such a manner that the top end is advanced by 90° from the bottom end in a rotation direction. The side ends., between the top ends and the bottom ends, of the four panels 1a, 1b, 1c, and 1d are fully in contact with a single cylinder. Each of the four panels 1a, 1b, 1c, and 1d is a transparent plastic plate and one surface of each panel is coated with a phosphor.

The flat display device 2 is a general liquid crystal display device. Being high in straightness of emitted light, the liquid crystal display device makes it possible to display images (sectional images) on the panels 1a, 1b, 1c, and 1d of the solid diffusion panel 1 which is located in the optical path of image light over the display screen of the liquid crystal display device without the need for using lenses or the like. The rotation speed of the solid diffusion panel 1 is set at 900 rpm (i.e., 15 Hz).

In this embodiment, an image can be updated 60 times per second at each point because the solid diffusion panel 1 is composed of the four panels 1a, 1b, 1c, and 1d. The four divisional panels are now called a first panel, a second panel, a third panel, and a fourth panel. When with rotation of the solid diffusion panel 1 the second panel comes to the same position as an image was displayed on the first panel by image light emitted from the display screen of the flat display device 2, the displayed image of the flat display device 2 is updated. Similar operations are performed repeatedly thereafter, whereby a person 8 watching the solid diffusion panel 1. feels as if the solid image being displayed therein were moving.

The synchronization between the rotation of the solid diffusion panel 1 and the updating of a displayed image of the flat display device 2 is taken by attaching a rotary encoder to the rotary shaft 9 of the solid diffusion panel 1 and supplying rotation detection pulse signal to the computer system 5 via a position information signal line 6. The computer system 5 updates the signals to be output to the flat display device 2 in response to the rotation detection pulse signal.

Data of a solid image to be displayed by the solid diffusion panel 1 are generated by the computer system 5 (as in the first embodiment). The solid image is decomposed into sectional images by the following processing. Original data of the solid image, which are expressed. by X, Y, and Z coordinates, are converted into polar-coordinate data which are expressed by r, Θ, and z coordinates (r: length of radius vector; Θ: polar angle) in the entire space. A ring buffer structure is employed in the Z direction for each point represented by r and Θ. For a sectional image obtained by cutting by the solid diffusion panel 1, a pointer indicating a Z position of each point represented by r and Θ is set. And one sectional image is generated by collecting data indicated by the pointer.

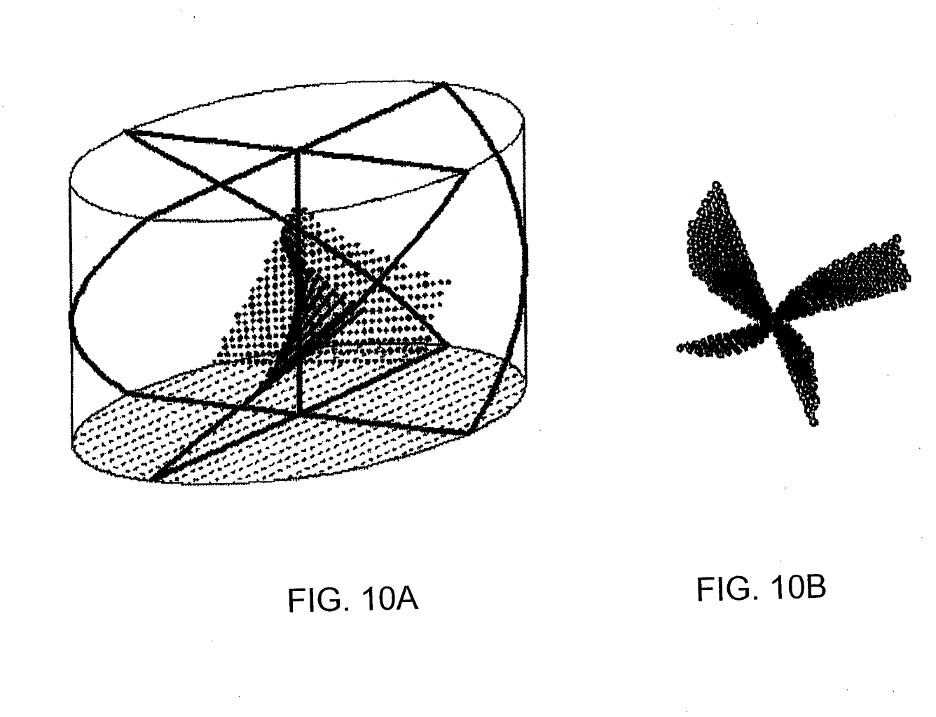

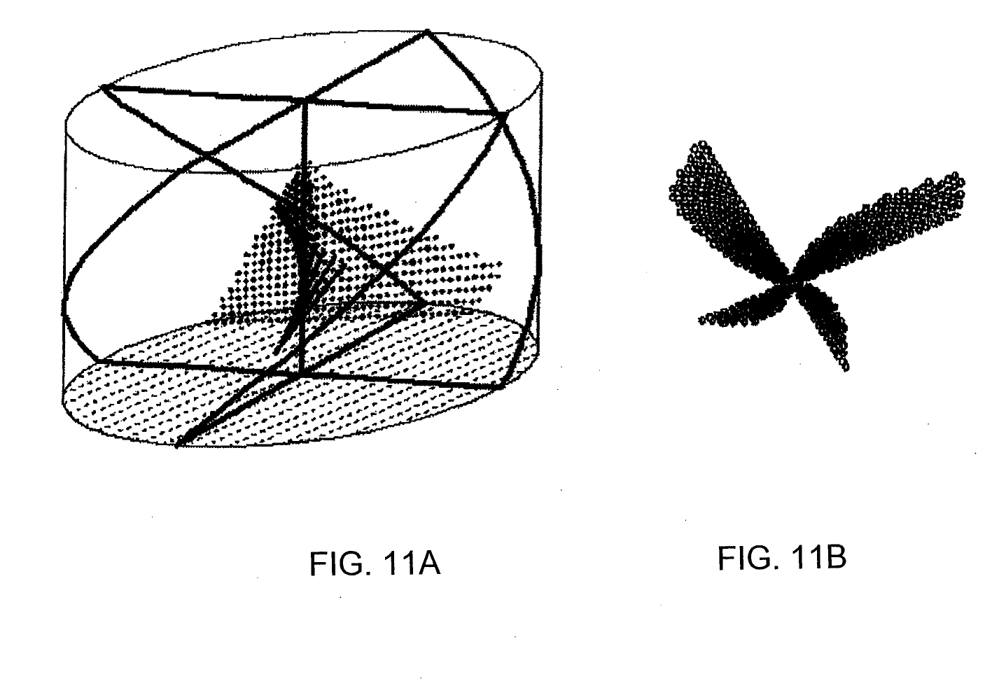

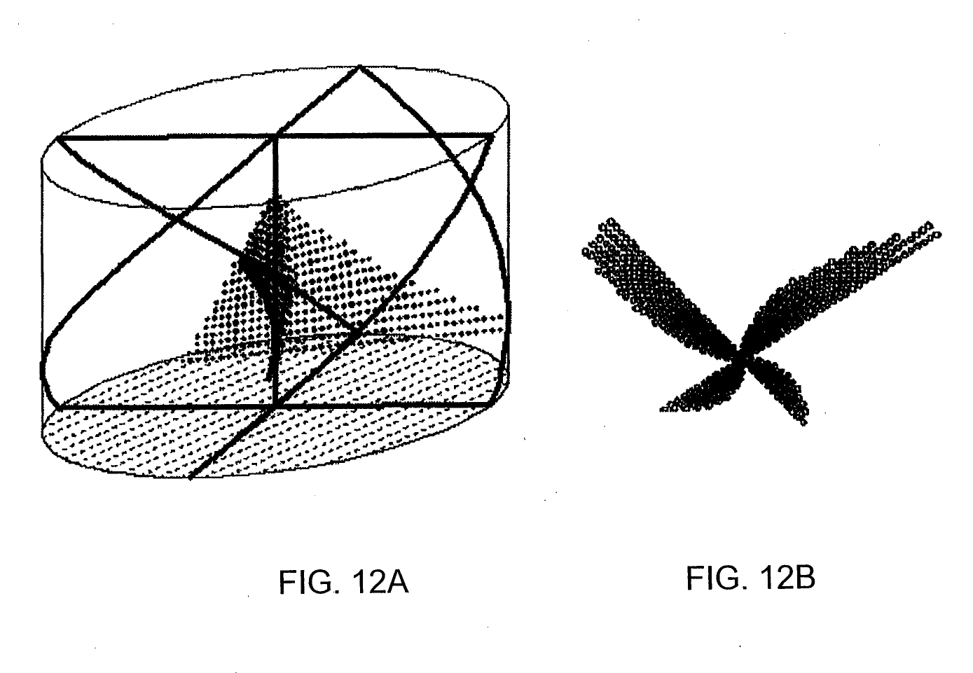

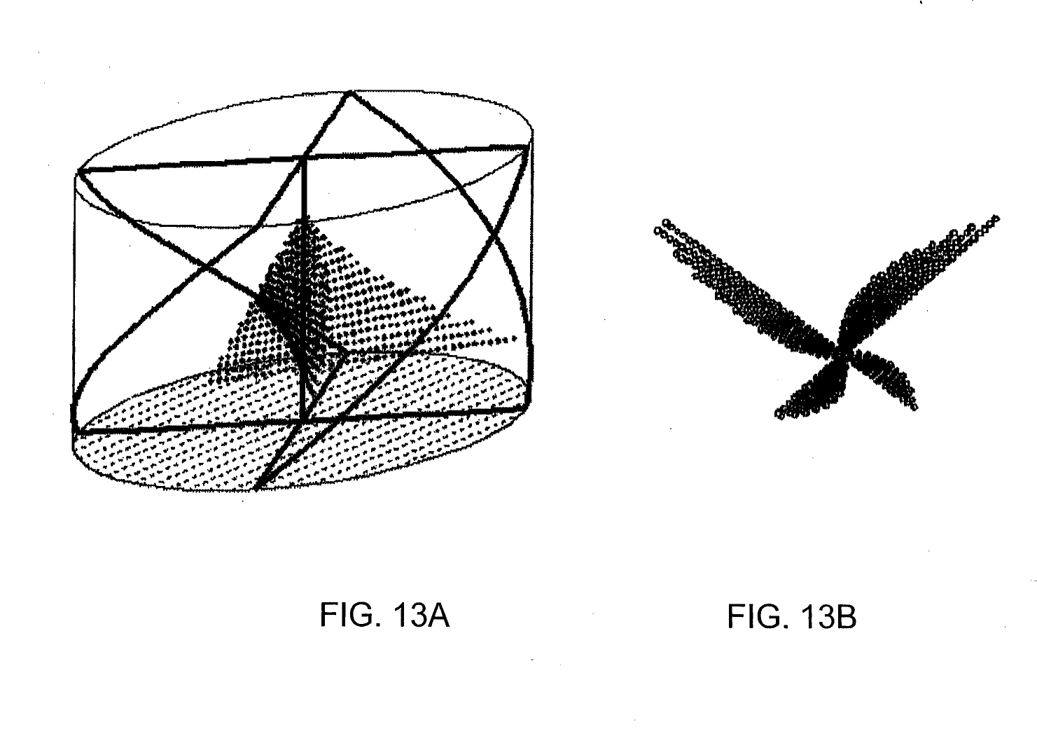

The height Z of a point of the surface of each panel of the solid diffusion panel 1 is given by
Z=a*Θ
where a is a constant. Therefore, as the solid diffusion panel 1 rotates, the height varies in proportional to an angle variation. Therefore, a sectional image (i.e., an image obtained by cutting a solid image by the solid diffusion panel 1) can be displayed quickly by changing the pointer by one every time the solid diffusion panel 1 is rotated by a prescribed angle. FIG. 10A-10B to FIG. 13A-13B show solid images displayed in the solid diffusion panel 1 and images displayed on the display screen of the flat display device 2. A 3D solid image can be displayed in a space as in the first embodiment.

Although the above processing is performed by software of the computer system 5, higher speed processing is possible when the above processing is performed by hardware such as an LSI since the processing is performed with a simple calculation. The solid diffusion panel 1 may be driven by combining rotation and reciprocation in the depth direction.

### Embodiment 3

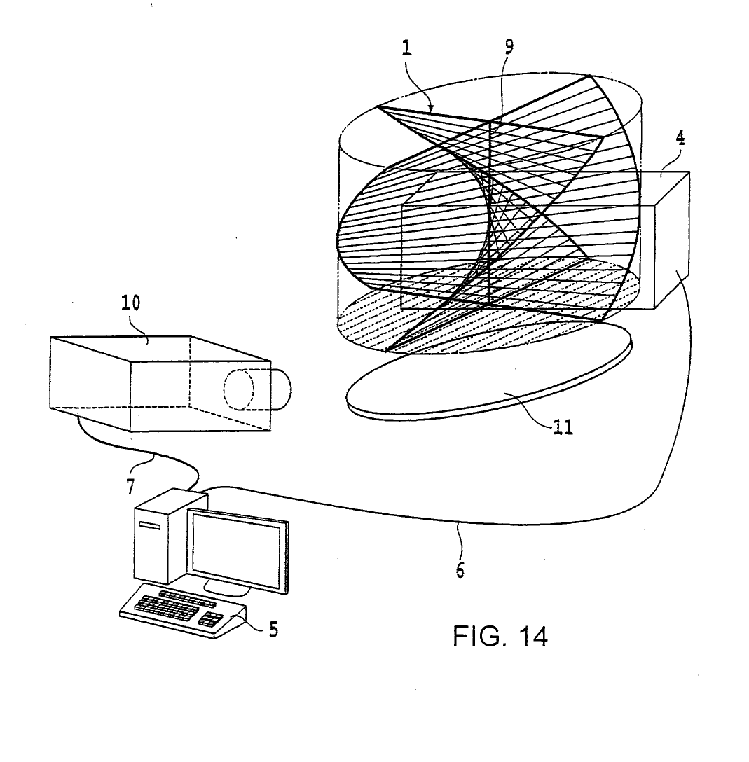

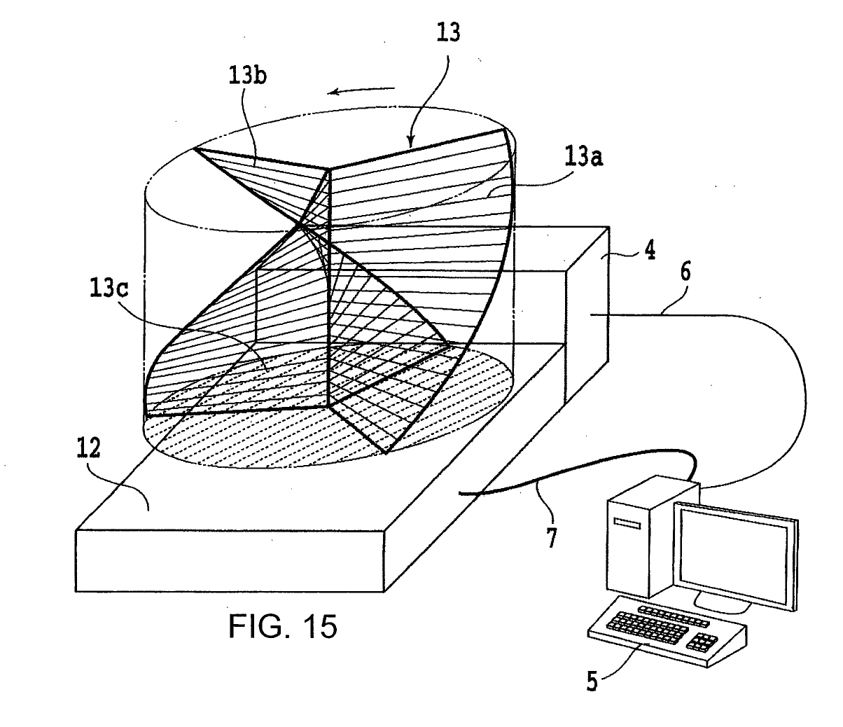

This embodiment, whose entire configuration is shown in FIG. 14, is similar in configuration to the second embodiment and is different from the latter in that a liquid crystal projector 10 is used as a display apparatus. Since the liquid crystal projector 10 incorporates an optical system for enlarged display, a mirror 11 is disposed to convert projection light coming from the liquid crystal projector 10 into parallel light, which is projected onto the solid diffusion panel 1. The same processing as in the second embodiment is performed except portions relating to the above optical system. The liquid crystal projector 10 and the mirror 11 may be designed so as to be dedicated to the invention, in which case the apparatus can be made more efficient.

### Embodiment 4

This embodiment employs an EL display device 12 and a solid diffusion panel 13 as a display apparatus. The solid diffusion panel 13 is composed of three panels 13a, 13b, and 13c, which are fixed to a rotary shaft 9 so as to be arranged at angular intervals of 120°. The EL display device 12 displays a monochrome image.

The bottom end and the top end of each panel are straight, and each panel is curved in such a manner that the top end is advanced by 120° from the bottom end in a rotation direction. The side ends, between the top ends and the bottom ends, of the three panels 13a, 13b, and 13c are fully in contact with a single cylinder. The three panels 13a, 13b, and 13c are curved plates in which blue, red, and green color conversion materials are buried, respectively. When illuminated with monochrome image light coming from the EL display device 12, the three panels 13a, 13b, and 13c reflect it to produce blue, red, and green light beams (the three primary colors of light).

The image processing may be performed in the same manner as in the second embodiment. In this embodiment, monochrome light is emitted and reflected so as to be converted into blue, red, and green light beams (the three primary colors of light), whereby a viewer can see a spatially synthesized target color image because of the afterimage effect.

It will be appreciated by those skilled in the art that the invention may be practiced otherwise than as specifically described herein without departing from the scope thereof.

What is claimed is:

1. A display apparatus for a 3D solid image, comprising:
a display device for displaying a two-dimensional image;
an at least partially transparent reflection member that is configured to be moved in a depth direction and has, in an optical path of light emitted from a display screen of the display device, a surface for reflecting the light emitted from the display screen of the display device;
driving means for driving the reflection member so as to move it periodically in the depth direction; and
image data generating means for generating data of the two-dimensional image to be displayed by the display device so that a sectional image as obtained by cutting a 3D solid image by the surface of the reflection member being moved will be drawn on the surface of the reflection member in synchronism with a movement of the reflection member by means of the light emitted from the display screen of the display device.

2. The display apparatus for a 3D solid image according to claim 1, wherein the reflection member has plural reflection surfaces.

3. The display apparatus for a 3D solid image according to claim 1, wherein a frequency of the movement of the reflection member is higher than or equal to 5 Hz.

4. The display apparatus for a 3D solid image according to claim 1, wherein the driving means drives the reflection member so as to translate it periodically in the optical path of light emitted from the display screen of the display device.

5. The display apparatus for a 3D solid image according to claim 1, wherein the driving means drives the reflection member so as to rotate it periodically in the optical path of light emitted from the display screen of the display device.

6. The display apparatus for a 3D solid image according to claim 5, wherein the reflection member is shaped so as to include part of a curved surface which is expressed as
X=r*cos Θ
Y=r*sin Θ
Z=a*Θ
where X, Y, and Z are coordinates of the three-dimensional dimensional orthogonal coordinate system, r and Θ are a length of a radius vector and a polar angle of the polar coordinate system, and a is a constant.

7. The display apparatus for a 3D solid image according to claim 1, wherein glass beads are adhered to the surface of the reflection member.

8. The display apparatus for a 3D solid image according to claim 1, wherein a fluorescent paint is adhered to the surface of the reflection member.

9. The display apparatus for a 3D solid image according to claim 1, wherein the display device is a flat display device.

10. The display apparatus for a 3D solid image according to claim 1, wherein the display device is a projection display device.

11. The display apparatus for a 3D solid image according to claim 1, further comprising an optical system disposed between the reflection member and the display device, for changing at least one of a traveling direction and an image forming position of light emitted from the display screen of the display device.

12. The display apparatus for a 3D solid image according to claim 11, wherein the optical system is moved in synchronism with the reflection member.

13. The display apparatus for a 3D solid image according to claim 1, wherein the image data generating means generates the two-dimensional image data in synchronism with a signal that is supplied from the driving means and relates to the driving of the reflection member.

14. The display apparatus for a 3D solid image according to claim 1, wherein the display device displays a monochrome two-dimensional image and the reflection member has plural reflection surfaces which are provided with materials that reflect light while converting it into light beams of different colors, respectively, so that a color solid image is synthesized.

15. A display apparatus for a 3D solid image, comprising plural display apparatus for a 3D solid image according to claim 1 which are arranged adjacent to each other so that a 3D solid image is displayed by the plural reflection members in a divisional manner.
